(19) United States
(12) Patent Application Publication
(10) Pub. No.: US 2026/0230458 A1
(43) Pub. Date: Aug. 6, 2026

(54) Keys for a Connectivity Process and a Security Protocol Process

(71) Applicant: Telefonaktiebolaget LM Ericsson (publ), Stockholm (SE)

(72) Inventors: Vesa Lehtovirta, Espoo (FI); Helena Vahidi Mazinani, Lund (SE)

(21) Appl. No.: 19/153,175

(22) PCT Filed: Feb. 3, 2024
(86) PCT No.: PCT/IB2024/050989

§ 371 Date: Aug. 1, 2025

Related U.S. Application Data
(60) Provisional application No. 63/445,211, filed on Feb. 13, 2023.

(51) Int. Cl. H04L 9/40

(52) U.S. Cl. CPC H04L 63/06; H04L 63/08

(57) ABSTRACT

There is provided a method performed by a user equipment, UE. The method comprises performing (402) a connectivity process with a first network node to generate a first key for use by the UE and the first network node. The UE performs the connectivity process using an identifier, and performing the connectivity process comprises sending, to the first network node, a correlation identifier. The method further comprises performing (404) a security protocol process with the first network node using the first key, wherein performing the security protocol process comprises sending, to the first network node, the correlation identifier.

### TECHNICAL FIELD

This disclosure relates to keys for a connectivity process and a security protocol process, and in particular to methods performed by a user equipment (UE) and a network node.

### BACKGROUND

### Ongoing 3GPP Studies for the Support of Non-3GPP Access for SNPN

The 3^{rd} Generation Partnership Project (3GPP) TR 23.700-08 v 1.5.0 “Study on enhanced support of Non-Public Networks; Phase 2” studies “Key Issue #2: Support of Non-3GPP access for SNPN”. Clause 5.2.1 of TR 23.700-08 states: “Currently the 3GPP specifications do not support direct connection to SNPN via non-3GPP access networks” and “One objective of this key issue is to enable the 5GS to support direct connection of non-3GPP access networks to the SNPN's 5GC”. 3GPP TR 33.858 v0.4.0 “Study on security aspects of enhanced support of Non-Public Networks phase 2” studies Key issue #1: Security of non-3GPP access for SNPN where one aspect is key identification when using anonymous SUCI.

### Authentication to 5GC via Trusted Non-3GPP Access

3GPP TS 33.501 v17.8.0 “Security architecture and procedures for 5G system (Release 17)” includes a figure:
FIG. 7A.2.1-1: “Registration\Authentication and PDU Session establishment for trusted non-3GPP access”. This FIG. 7A.2.1-1 is FIG. 1 of the present disclosure. Clause 7A.2.1 “Authentication for trusted non-3GPP access” of 3GPP TS 33.501 recites (noting that reference numbers in the text below, e.g., “RFC 7296 [25]” are from the specification and do not match with the References cited in this disclosure):

“This clause specifies how a UE is authenticated to 5G network via a trusted non-3GPP access network.

This is based on the specified procedure in TS 23.502 [xxx] clause 4.12a.2.2 “Registration procedure for trusted non-3GPP access”. The authentication procedure is similar to the authentication procedure for trusted non-3GPP access defined in clause 7.2.1 with few differences, which are mentioned below:
0. The UE selects a PLMN and a TNAN for connecting to this PLMN by using the Trusted Non-3GPP Access Network selection procedure specified in TS 23.501 [2] clause 6.3.12. During this procedure, the UE discovers the PLMNs with which the TNAN supports trusted connectivity (e.g. “5G connectivity”).
1. A layer-2 connection is established between the UE and the TNAP. In case of IEEE 802.11 [80], this step corresponds to an 802.11 [80] Association. In case of PPP, this step corresponds to a PPP LCP negotiation. In other types of non-3GPP access (e.g. Ethernet), this step may not be required.
2-3. An EAP authentication procedure is initiated. EAP messages shall be encapsulated into layer-2 packets, e.g. into IEEE 802.3/802.1x packets, into IEEE 802.11/802.1x packets, into PPP packets, etc. The UE provides a NAI that triggers the TNAP to send an AAA request to a TNGF. Between the TNAP and TNGF the EAP packets are encapsulated into AAA messages.
4-10. An EAP-5G procedure is executed as specified in clause 7.2.1 with the following modifications:
   The EAP-5G packets shall not be encapsulated into IKEv2 packets. The UE shall also include a UE Id in the AN parameters, e.g. a 5G-GUTI if available from a prior registration to the same PLMN.
   A K_{TNGF} as specified in clause Annex A.9 (equivalent to K_{N31WF}) is created in the UE and in the AMF after the successful authentication. The K_{TNGF} is transferred from the AMF to TNGF in step 10a (within the N2 Initial Context Setup Request).
   The TNAP is a trusted entity. The TNGF shall generate the K_{TNAP} as specified in Annex A.22 and transfers it from TNGF to TNAP in step 10b (within an AAA message).
   After receiving the TNGF key from AMF in step 10a, the TNGF shall send to UE an EAP-Request/5G-Notification packet containing the “TNGF Contact Info”, which includes the IP address of TNGF. After receiving an EAP-Response/5G-Notification packet from the UE, the TNGF shall send message 10b containing the EAP-Success packet.
11. The common TNAP key is used by the UE and TNAP to derive security keys according to the applied non-3GPP technology and to establish a security association to protect all subsequent traffic. In case of IEEE 802.11 [80], the K_{TNAP} is the Pairwise Master Key (PMK) and a 4-way handshake is executed (see IEEE 802.11 [80]) which establishes a security context between the WLAN AP and the UE that is used to protect unicast and multicast traffic over the air. All messages between UE and TNAP are encrypted and integrity protected from this step onwards.
NOTE 1: whether step 11 is performed out of the scope of this document. The current procedure assumes the encryption protection over Layer-2 between UE and TNAP is to be enabled.
12. The UE receives IP configuration from the TNAN, e.g. with DHCP.
13. The UE shall initiate an IKE_INIT exchange with the TNGF. The UE has received the IP address of TNGF during the EAP-5G signalling in step 9b, subsequently, the UE shall initiate an IKE_AUTH exchange and shall include the same UE Id (i.e. SUCI or 5G-GUTI) as in the UE Id provided in step 5. The common K_{TIPSe} is used for mutual authentication. The key K_{TIPSec} is derived as specified in Annex A.22.NULL encryption is negotiated as specified in RFC 2410 [81]. After step 13c, an IPsec SA is established between the UE and TNGF (i.e. a NWt connection) and it is used to transfer all subsequent NAS messages. This IPsec SA does not apply encryption but only apply integrity protection.
14. After the NWtp connection is successfully established, the TNGF responds to AMF with an N2 Initial Context Setup Response message.
15.Finally, the NAS Registration Accept message is sent by the AMF and is forwarded to UE via the established NWt connection.
16-18. The UE initiates a PDU session establishment. This is carried out exactly as specified in TS 23.502 [8] clause 4.12a.5. The TNGF may establish one or more IPSec child SA's per PDU session.
19. User plane data for the established PDU session is transported between the UE and TNGF inside the established IPSec child SA.”

### SUMMARY

There currently exist certain challenge(s).

### Problem With Anonymous Subscription Concealed Identifier (SUCI)

In the current specifications (3GPP TS 33.501, clause 7A.2.1 and 3GPP TS 23.502 v17.7.0 “Procedures for the 5G System (5GS)”, clause 4.12a.2) it has been specified that when the User Equipment (UE) registers to 5^{th} Generation Core (5GC) via trusted non-3GPP access, it first performs authentication (i.e. establishes connectivity) with 5GC via the non-3GPP access and Trusted Non-3GPP Gateway Function (TNGF) to get needed keys e.g., for the non-3GPP access, and local Internet Protocol (IP) address. The UE then sets up an IP Security (IPsec) tunnel to the TNGF and the rest of the registration procedure is performed over the IPsec tunnel. The keys derived during the authentication are used to secure the IPsec tunnel.

In current specifications it is specified that the UE initiates an IKE_AUTH exchange with the TNGF and provides its identity. The identity provided by the UE in the Internet Key Exchange version 2 (IKEv2) signalling should be the same as the UE Identifier (Id) (SUCI or 5^{th} Generation (5G)-Globally Unique Temporary Identity (GUTI) included in the Access Network (AN) parameters in the previous authentication run. This enables the TNGF to locate the TNGF key that was created before for this UE, during the authentication. The TNGF key is used for mutual authentication.

For trusted non-3GPP (N3GPP) access, an issue has been identified with the identification of the key K_{TNGF} in the case of using anonymous SUCI which is used with some Extensible Authentication Protocol (EAP) methods. Namely, when anonymous SUCI is used, the UE sends string “anonymous” or an empty string instead of the UE specific SUCI value during authentication. Therefore, this value cannot be used in the IKE_AUTH exchange for locating the correct TNGF key.

### Existing Solutions

The following solutions have been proposed so far in 3GPP TR 33.858. The following also includes the clause numbers from the TR.
6.3 Solution #3: Use of anonymous SUCI in trusted non-3-GPP access for SNPN
6.3.1 Introduction

This solution solves Key issue #1 in the case of using anonymous SUCI in trusted non-3GPP access.

When introducing non-3GPP access in Standalone Non-Public Network (SNPN) it is assumed that most security procedures can be reused. However, the use of anonymous SUCI is only applicable to SNPNs so there are not yet any procedures specified for this case in relation to non-3GPP access.

In the current procedures for trusted non-3GPP access in clause 7A.2.1 of TS 33.501, it is specified to use the SUCI/GUTI to map the user to the correct K_{TNGF} in step 13. When using anonymous SUCI, this is not a good solution since an anonymous SUCI is not unique. Instead, another identifier is needed. This solution proposes to use a hash of the key K_{TNGF} as identifier in case anonymous SUCI is used during the authentication towards the SNPN.

This solution defines adaptations of existing procedures needed to support the use of anonymous SUCI in trusted access for SNPN.
6.3.2 Solution details

Procedures in clause 7A.2.1 of TS 33.501 are reused with the following exception:
In step 13, if the construction of SUCI as described in clause 6.12 of TS 33.501 cannot be used, then a new type of identifier is used. The new identifier is proposed to be a hash of the key K_{TNGF}. (potentially using some additional input). It is proposed to send the new identifier using the IDi payload.

It is already specified in section 3.5 of IEFT RFC 7296 Internet Key Exchange Protocol Version 2 (IKEv2) that the ID payload used for transport of IDi can be used to transfer a key identifier by setting the ID Type to ID_KEY_ID. Support of this ID Type is mandatory. The RFC does not specify how such a key identifier is generated. The proposal here is thus to use a hash of the key K_{TNGF} potentially using some additional input to create a key identifier.
6.5 Solution #5: Anonymous authentication during connection establishment in trusted non-3GPP network access.
6.5.1 Introduction

This is a solution to KI #1.

When a UE accesses a trusted non-3GPP access network, it uses either SUCI or 5G-GUTI for identification. In case of a Non-Public Network (NPN) deployment, the UE might use an anonymous identifier when the EAP method supports its, as specified in TS 33.501 clause 1.5 of Annex I. The anonymous identifier will protect the identity of the UE and makes it impossible to differentiate between a group of UE's using the same identifier namely the anonymous identifier. As the authentication and key derivation steps are independent of the IPsec establishment, the TNGF cannot link the authentication and derived key to a IKE_AUTH request—as the same identifier is used for multiple devices.

This solution provides a method to fill the gap caused by introducing the anonymous identifier which is already standardised in 3GPP TS 33.501 clause 1.5. The solution proposes, that the TNGF creates a unique temporary identifier, shares it after authentication alongside other information necessary to establish the IPsec connection (e.g., TNGF address), to the UE. When the UE initiates the establishment of the IPSec channel, the UE uses the temporary identifier as identifier and thereby enables the TNGF to identify the correct key material (KTNGF) for the session.

The temporary identifier is only applicable when the anonymous identifier is used, therefore it's proposed as an optional parameter.
6.5.2 Solution Details

Procedures in clause 7A.2.1 of 3GPP TS 33.501 are reused with the following exception:
In step 9b, when an anonymous identifier has been used in step 5, transfer a unique temporary identifier, allocated by the TNGF, to the UE alongside the TNGF address.
In step 13b, use the unique temporary identifier provided in step 9b as IDi, in case an anonymous identifier was used in step 5.

The allocation of a temporary identifier by the TNGF, distributed to the UE, enables the TNGF to identify the KTNGF which is used in the IKE_AUTH procedure in step 13b and c.
6.6 Solution #6: Trusted non-3GPP access for SNPN
6.6.1 Introduction

This solution addresses key issue #1.

The normal trusted access procedures are used, only if the UE sends an anonymous SUCI, then the TNGF and the UE use the assigned IP address, which is unique within the TNGF, as identifier in the IDi according to RFC 7296.
6.6.2 Solution Details

This solution reuses the trusted non-3GPP access authentication procedure in Public Land Mobile Network (PLMN) scenarios in clause 7A.2.1 of 3GPP TS 33.501 with the following modifications:

If the UE sends an anonymous SUCI in step 5 of the procedure, then the TNGF will use the IP address, which the TNGF assigns to the UE as unique identifier to bind the security key. In step 13, the UE shall include the ID_IPV4_ADDR or ID_IPV6_ADDR with the assigned IP address in the IDi. The TNGF uses the received IP address to locate the K_TIPSec for the connection.

Certain aspects of the disclosure and their embodiments may provide solutions to these or other challenges.

The techniques described herein provide that when the UE sends an identifier (also referred to herein as a “UE identifier”) in the beginning of the connectivity process in step 5 of the above FIG. 7A.2.1-1 from clause 2.2.3 of 3GPP TS 33.501, the UE generates a correlation identifier and includes that correlation identifier in step 5 with, or as part of, the identifier. For example, it could be type1.rid678.schid0.useridanonymous-9876543@example.com, where 9876543 is the correlation identifier. The identifier sent in the beginning of the connectivity process in step 5 can be a SUCI, a 5G-GUTI or an anonymous SUCI. In particular implementations, the identifier is an anonymous SUCI.

When the UE later sends the IKE_AUTH message in step 13 of FIG. 7A.2.1-1 (clause 2.2.3 of 3GPP TS 33.501), the UE can include the same correlation ID as part of the UE identifier in the IKE IDi field, i.e., type 1.rid678.schid0.useridanonymous-9876543@example. com. The correlation ID allows the TNGF to locate the correct TNGF key and successfully perform the IKE process.

The correlation identifier should be fresh (new) for each EAP protocol run, and should be generated by the UE in such a way that it is not possible to link two separate correlation identifiers together.

The following expresses the techniques described herein in more general terms:

When using a UE identifier (such as a SUCI, 5G-GUTI or an anonymous identifier (like an anonymous SUCI)) in an authentication protocol (e.g., EAP) when accessing a network, in a first authentication run (e.g., EAP) the UE generates and sends a correlation identifier to the network node (e.g., TNGF). The network node (e.g., TNGF) stores the correlation identifier. The authentication run (e.g., EAP) results in a key generated in the UE and network side (e.g., TNGF).

When the UE later starts another authentication run (IKE_AUTH exchange) with the network node (e.g., TNGF), the UE sends the same correlation identifier in IKE_AUTH. The correlation identifier enables the network node (e.g., TNGF) to correlate the two authentications runs. More specifically, the correlation identifier helps the network node (e.g., TNGF) to find the key (e.g., K-TNGF or a key derived from K-TNGF like K-TIPsec) which was generated during the first authentication run (EAP), and uses the key to successfully perform the second authentication process (e.g., a security protocol process, such as IKE).

Certain embodiments may provide one or more of the following technical advantage(s). The techniques provide that, for trusted N3GPP access, the correlation identifier enables the network node to identify the correct key (e.g. K-TNGF) for the UE when the UE uses an identifier such as an anonymous SUCI, and does so without introducing additional signalling between the UE and the TNGF/network.

According to a first aspect, there is provided a method performed by a UE. The method comprises: performing a connectivity process with a first network node to generate a first key for use by the UE and the first network node. The UE performs the connectivity process using a UE identifier, and performing the connectivity process comprises sending, to the first network node, a correlation identifier. The method also comprises performing a security protocol process with the first network node using the first key, wherein performing the security protocol process comprises sending, to the first network node, the correlation identifier.

According to a second aspect, there is provided a method performed by a first network node. The method comprises performing a connectivity process with a UE to generate a first key for use by the UE and the first network node. The UE performs the connectivity process using a UE identifier, and performing the connectivity process comprises receiving, from the UE, a correlation identifier. The method also comprises storing the first key and the correlation identifier for the UE; and performing a security protocol process with the UE. Performing the security protocol process comprises receiving, from the UE, the correlation identifier, and using the correlation identifier to retrieve the first key.

According to a third aspect, there is provided a computer program product comprising a computer readable medium having computer readable code embodied therein, the computer readable code being configured such that, on execution by a suitable computer or processor, the computer or processor is caused to perform the method according to the first aspect, the second aspect or any embodiment thereof.

According to a fourth aspect, there is provided a UE configured to perform the method according to the first aspect or any embodiment thereof.

According to a fifth aspect, there is provided a UE comprising a processor and a memory, said memory containing instructions executable by said processor whereby said UE is operative to perform the method according to the first aspect or any embodiment thereof.

According to a sixth aspect, there is provided a network node configured to perform the method according to the second aspect or any embodiment thereof.

According to a seventh aspect, there is provided a network node comprising a processor and a memory, said memory containing instructions executable by said processor whereby said network node is operative to perform the method according to the second aspect or any embodiment thereof.

### BRIEF DESCRIPTION OF THE DRAWINGS

Some of the embodiments contemplated herein will now be described more fully with reference to the accompanying drawings, in which:

FIG. 1 is a copy of FIG. 7A.2.1-1: “Registration\Authentication and PDU Session establishment for trusted non-3GPP access” from 3GPP TS 33.501v 17.8.0 ;

FIG. 2 is a copy of FIG. 4.2.8.2.1-2: “Non-roaming architecture for 5G Core Network with trusted non-3GPP access” from 3GPP TS 23.501v 17.7.0;

FIG. 3 is a modified version of FIG. 7A.2.1-1: “Registration\Authentication and PDU Session establishment for trusted non-3GPP access” from 3GPP TS 33.501 v 17.8.0 according to some embodiments;

FIG. 4 is a flow chart illustrating a method performed by a UE in accordance with some embodiments;

FIG. 5 is a flow chart illustrating a method performed by a first network node in accordance with some embodiments;

FIG. 6 shows an example of a communication system in accordance with some embodiments;

FIG. 7 shows a UE in accordance with some embodiments;

FIG. 8 shows a RAN network node in accordance with some embodiments; and

FIG. 9 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

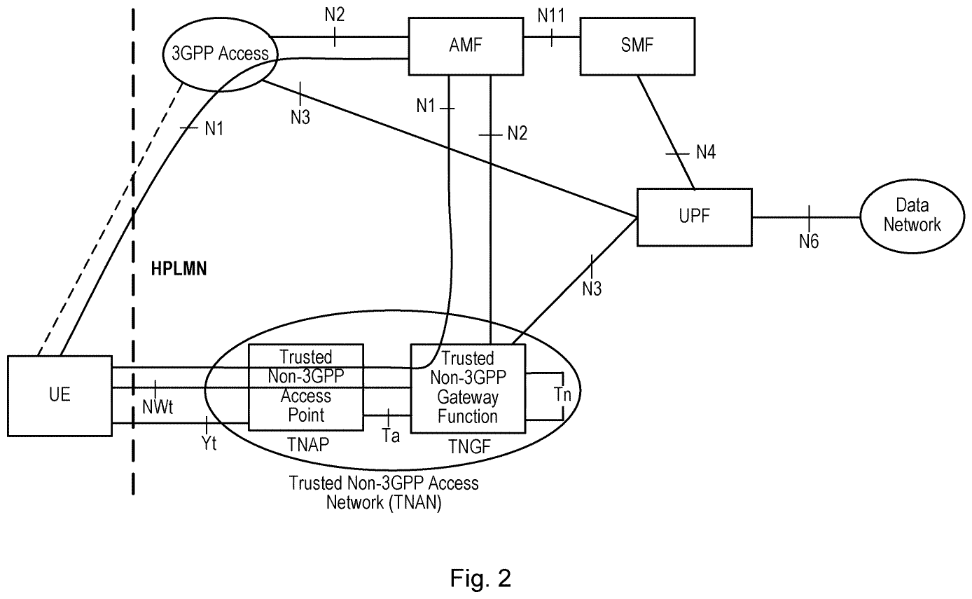

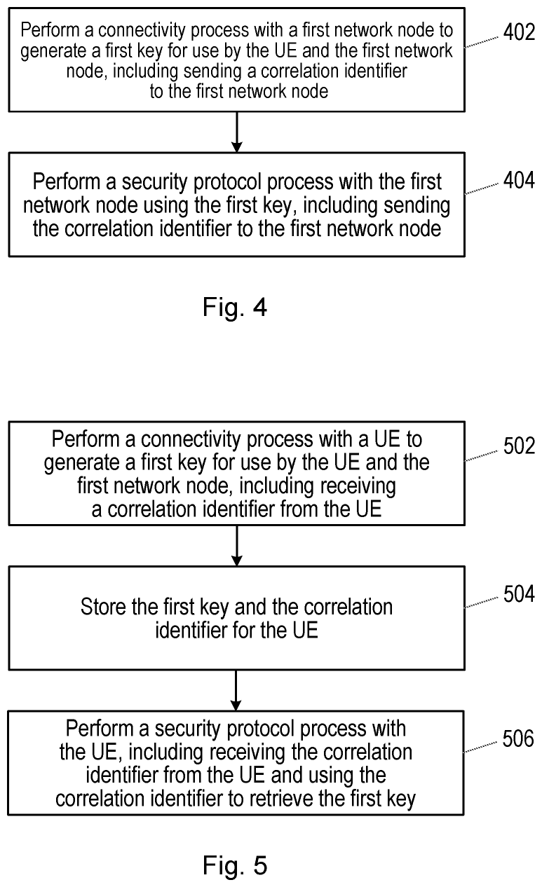

An exemplary communication system to which the techniques described herein can be applied is shown in FIG. 2. This figure is FIG. 4.2.8.2.1-2 from 3GPP TS 23.501 v17.7.0 System architecture for the 5G System (5GS) clause 4.2.8.2.1. In the standard, FIG. 4.2.8.2.1-2 is titled: Non-roaming architecture for 5G Core Network with trusted non-3GPP access.

FIG. 2 shows a UE that can be connected to Data Network via a User Plane Function (UPF) and either a 3GPP access network or a Trusted Non-3GPP Access Network (TNAN). The 3GPP network also includes an Access and Mobility Management Function (AMF), and a Session Management Function (SMF). The TNAN comprises a Trusted Non-3GPP Access Point (TNAP) and a Trusted Non-3GPP Gateway Function (TNGF). The TNGF connects to the AMF and UPF.

As noted above, when using a UE identifier (such as a SUCI, 5G-GUTI or an anonymous identifier (like an anonymous SUCI)) in an authentication protocol (e.g., EAP) when accessing a network, in a first authentication (connectivity) run/process (e.g., EAP) the UE generates and sends a correlation identifier to the network node (e.g., TNGF). The network node (e.g., TNGF) stores the correlation identifier. The authentication (connectivity) run/process (e.g., EAP) results in a key generated in the UE and network side (e.g., TNGF).

When the UE later starts another authentication (security protocol establishment) run/process (IKE_AUTH exchange) with the network node (e.g., TNGF), the UE sends the same correlation identifier in IKE_AUTH. The security protocol process is for setting up a security protocol between the UE and the network. The correlation identifier enables the network node (e.g., TNGF) to correlate the two authentication runs by the UE. More specifically, the correlation identifier helps the network node (e.g., TNGF) to find the key (e.g., K-TNGF or a key derived from K-TNGF like K-TIPsec) which was generated during the first authentication (connectivity) run (EAP), and uses the key to successfully perform the second authentication (security protocol) process (e.g., IKE).

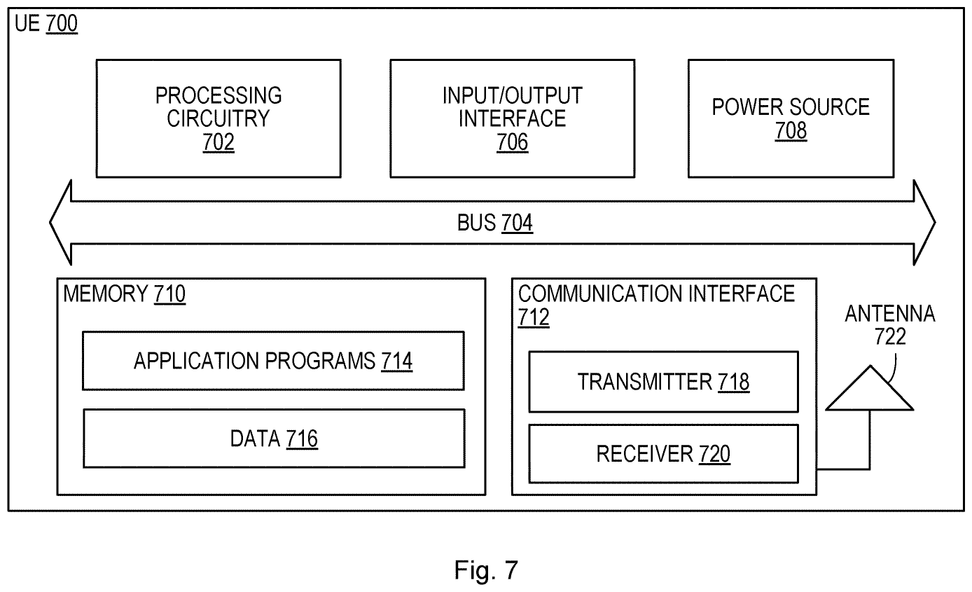

Thus, embodiments of the techniques described herein provide that when the UE sends a UE identifier in the beginning of the connectivity process in step 5 of FIG. 7A.2.1-1 from clause 2.2.3 of 3GPP TS 33.501, the UE generates a correlation identifier and includes that correlation identifier in step 5 with, or as part of, the UE identifier. For example, it could be type 1.rid678.schid0.useridanonymous-9876543@example. com, where 9876543 is the correlation identifier. The identifier sent in the beginning of the connectivity process in step 5 can be a SUCI, a 5G-GUTI or an anonymous SUCI. In particular implementations, the identifier is an anonymous SUCI.

When the UE later sends the IKE_AUTH message in step 13 of FIG. 7A.2.1-1 (clause 2.2.3 of 3GPP TS 33.501), the UE can include the same correlation ID as part of the UE identifier in the IKE IDi field, i.e., type1.rid678.schid0.useridanonymous-9876543@example. com. The correlation ID allows the TNGF to locate the correct TNGF key and successfully perform the IKE process.

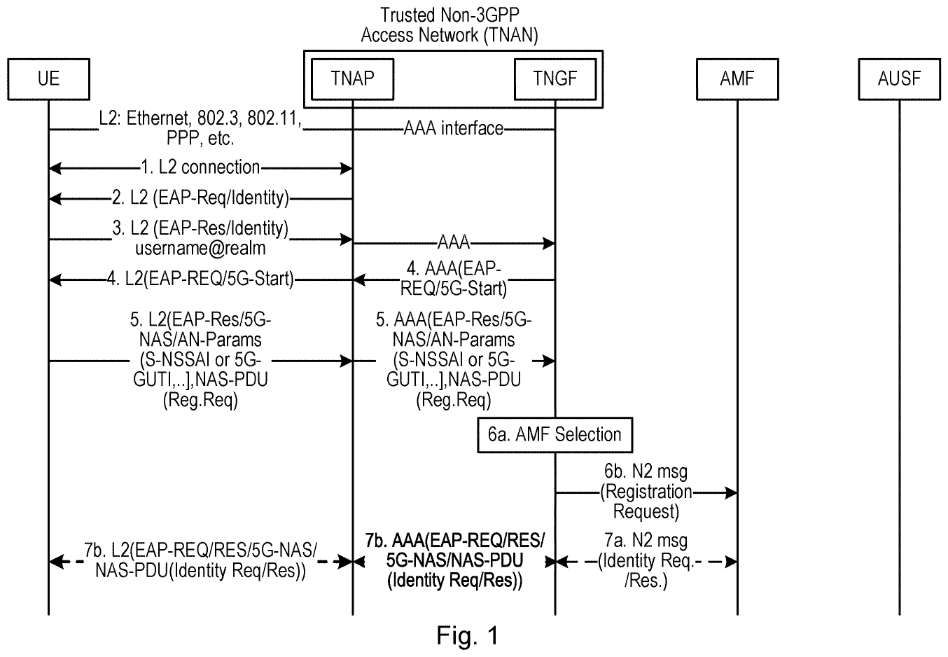

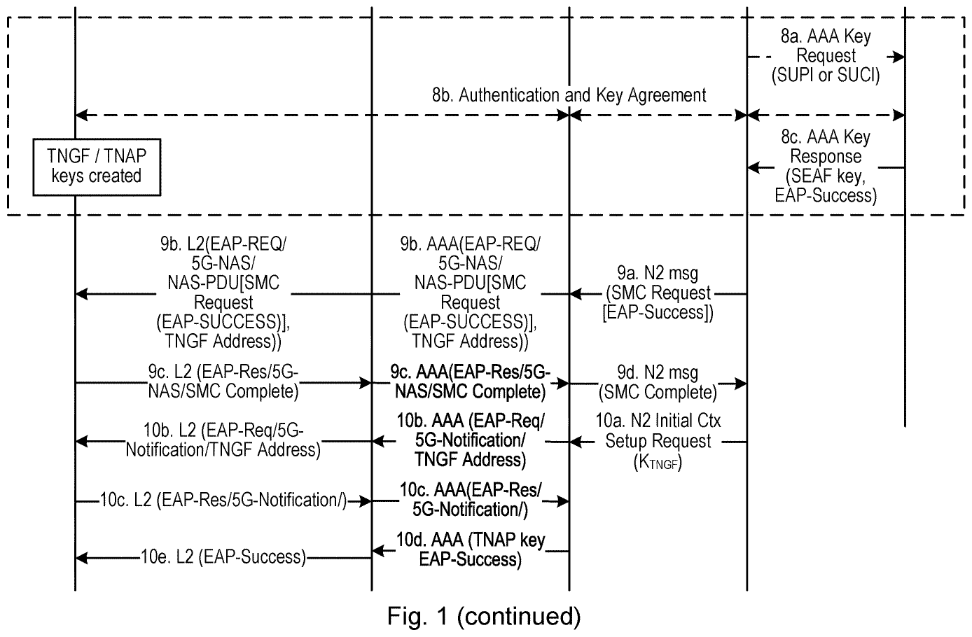

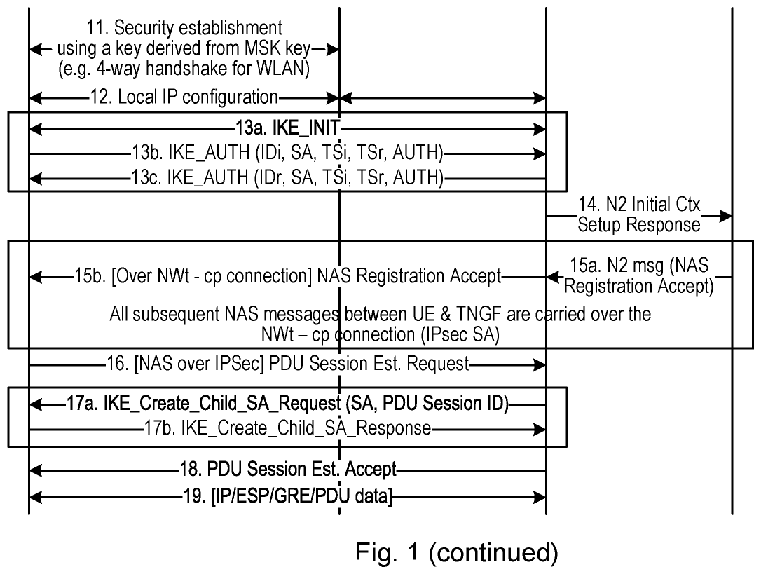

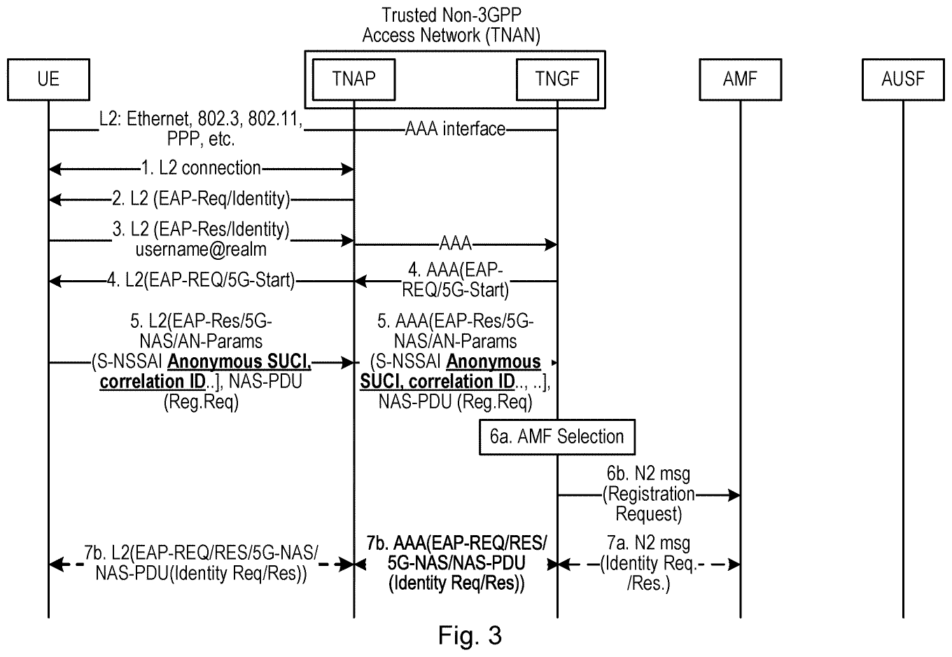

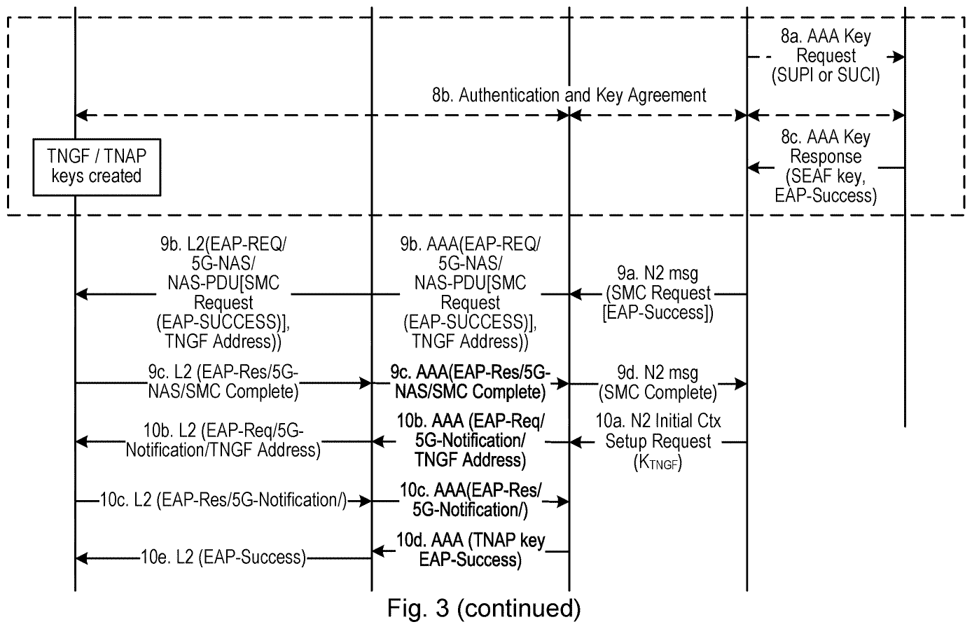

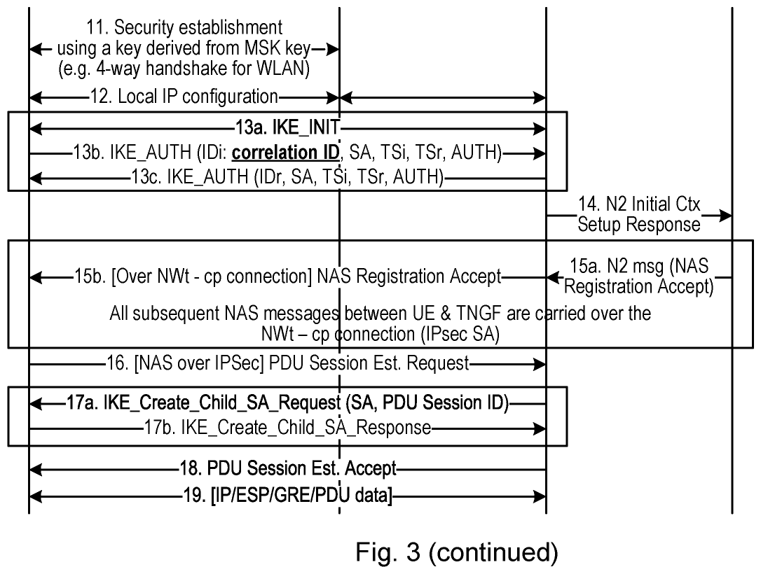

An embodiment of the new techniques presented herein is illustrated below with respect to FIG. 3 and Clause 7A.2.1 of 3GPP TS 33.501. FIG. 3 is a modified version of FIG. 7A.2.1-1 shown in FIG. 1. The new features provided by the techniques described herein are illustrated in the modified version of Clause 7A.2.1 with underline, and in FIG. 7A.2.1-1 (FIG. 3) with bold and underline. It will be appreciated that the following embodiment indicates one implementation of the techniques described herein into the 3GPP TS 33.501 and 3GPP TS 23.502 standards.
0. The UE selects a PLMN and a TNAN for connecting to this PLMN by using the Trusted Non-3GPP Access Network selection procedure specified in TS 23.501 [2] clause 6.3.12. During this procedure, the UE discovers the PLMNs with which the TNAN supports trusted connectivity (e.g. “5G connectivity”).
1. A layer-2 connection is established between the UE and the TNAP. In case of IEEE 802.11 [80], this step corresponds to an 802.11 [80] Association. In case of PPP, this step corresponds to a PPP LCP negotiation. In other types of non-3GPP access (e.g. Ethernet), this step may not be required.
2-3. An EAP authentication procedure is initiated. EAP messages shall be encapsulated into layer-2 packets, e.g. into IEEE 802.3/802.1x packets, into IEEE 802.11/802.1x packets, into PPP packets, etc. The UE provides a NAI that triggers the TNAP to send an AAA request to a TNGF. Between the TNAP and TNGF the EAP packets are encapsulated into AAA messages.
4-10. An EAP-5G procedure is executed as specified in clause 7.2.1 with the following modifications:
   The EAP-5G packets shall not be encapsulated into IKEv2 packets. The UE shall also include a UE Id in the AN parameters, e.g. a 5G-GUTI if available from a prior registration to the same PLMN or SUCI or an anonymous SUCI. The UE then generates a correlation ID which it sends in step 5 to the TNGF. The correlation ID is sent for example either as a new parameter with the Anonymous SUCI or in the anonymous SUCI parameter. For example, the anonymous SUCI can take the form: ‘anonymous:correlationID@realm’ or ‘correlationID@realm’. In more detail, the correlation ID can be sent within the AN-parameters or in the Registration Request or both.
   A K_{TNGF} as specified in clause Annex A.9 (equivalent to K_{N3IWF}) is created in the UE and in the AMF after the successful authentication. The K_{TNGF} is transferred from the AMF to TNGF in step 10a (within the N2 Initial Context Setup Request).
   The TNAP is a trusted entity. The TNGF shall generate the K_{TNAP} as specified in Annex A.22 and transfers it from TNGF to TNAP in step 10b (within an AAA message).
   After receiving the TNGF key from AMF in step 10a, the TNGF shall send to UE an EAP-Request/5G-Notification packet containing the “TNGF Contact Info”, which includes the IP address of TNGF. After receiving an EAP-Response/5G-Notification packet from the UE, the TNGF shall send message 10b containing the EAP-Success packet.
11. The common TNAP key is used by the UE and TNAP to derive security keys according to the applied non-3GPP technology and to establish a security association to protect all subsequent traffic. In case of IEEE 802.11 [80], the K_{TNAP} is the Pairwise Master Key (PMK) and a 4-way handshake is executed (see IEEE 802.11 [80]) which establishes a security context between the WLAN AP and the UE that is used to protect unicast and multicast traffic over the air. All messages between UE and TNAP are encrypted and integrity protected from this step onwards.
NOTE 1: whether step 11 is performed out of the scope of this document. The current procedure assumes the encryption protection over Layer-2 between UE and TNAP is to be enabled.
12. The UE receives IP configuration from the TNAN, e.g. with DHCP.
13. The UE shall initiate an IKE_INIT exchange with the TNGF. The UE has received the IP address of TNGF during the EAP-5G signalling in step 9b, subsequently, the UE shall initiate an IKE_AUTH exchange and shall include the same UE Id (i.e. SUCI or 5G-GUTI) as in the UE Id provided in step 5. In case the UE sent an anonymous identifier, like anonymous SUCI, to the TNGF in step 5, the UE will send the same correlation ID as the IDi value in IKE AUTH that it sent in step 5 with anonymous SUCI. The correlation ID is used by the TNGF to identify which K_{TNGF} or a key derived from the K-TNGF like K-TIPsec, is used in the IKE_AUTH procedure. The common K_{TIPSec} is used for mutual authentication. The key K_{TIPSec} is derived as specified in Annex A.22.NULL encryption is negotiated as specified in RFC 2410 [81]. After step 13 c, an IPsec SA is established between the UE and TNGF (i.e. a NWt connection) and it is used to transfer all subsequent NAS messages. This IPsec SA does not apply encryption but only apply integrity protection.
14. After the NWtp connection is successfully established, the TNGF responds to AMF with an N2 Initial Context Setup Response message.
15.Finally, the NAS Registration Accept message is sent by the AMF and is forwarded to UE via the established NWt connection.
16-18. The UE initiates a PDU session establishment. This is carried out exactly as specified in TS 23.502 [8] clause 4.12a.5. The TNGF may establish one or more IPSec child SA's per PDU session.
19. User plane data for the established PDU session is transported between the UE and TNGF inside the established IPSec child SA.

As noted in the modified step 5 above, the correlation ID can be sent either as a new parameter with the Anonymous SUCI or in the anonymous SUCI parameter. The correlation ID can be sent within the AN-parameters or in the Registration Request, or both. In some embodiments the anonymous SUCI can take the form: ‘anonymous:correlationID@realm’ or ‘correlationID@realm’.

Clause 6.12.2 of 3GPP TS 33.501 v 17.8.0 defines a Subscription concealed Identifier (SUCI) as follows:

The SUbscription Concealed Identifier, called SUCI, is a privacy preserving identifier containing the concealed SUPI. . . .

For SUPIs containing Network Specific Identifier, the UE shall construct the SUCI in NAI format with the following data fields:
realm part of the SUCI is set to the realm part of the SUPI.
username part of the SUCI is formatted as specified in TS 23.003 [19] using the SUPI Type, Routing Indicator, the Protection Scheme Identifier, the Home Network Public Key Identifier and the Scheme Output.

3GPP TS 23.003 v 17.8.0 “Numbering, addressing and identification” Clause 2.2B “Subscription Concealed Identifier (SUCI)” includes the following:

An anonymous SUCI is composed by setting the SUPI Type field to 1 (Network-Specific Identifier), using the null protection scheme, and where the scheme output corresponds to a username set to either the “anonymous” string or to an empty string (see IETF RFC 7542 [126], clause 2.4).

Thus, an anonymous SUCI includes a “username” part, and it will be appreciated that in the example ‘anonymous:correlationID@realm’ set out above, the string “anonymous” (and the correlation identifier) are in the “username” part of the SUCI. That is, “anonymous:correlationID” can be included in the username part of the SUCI.

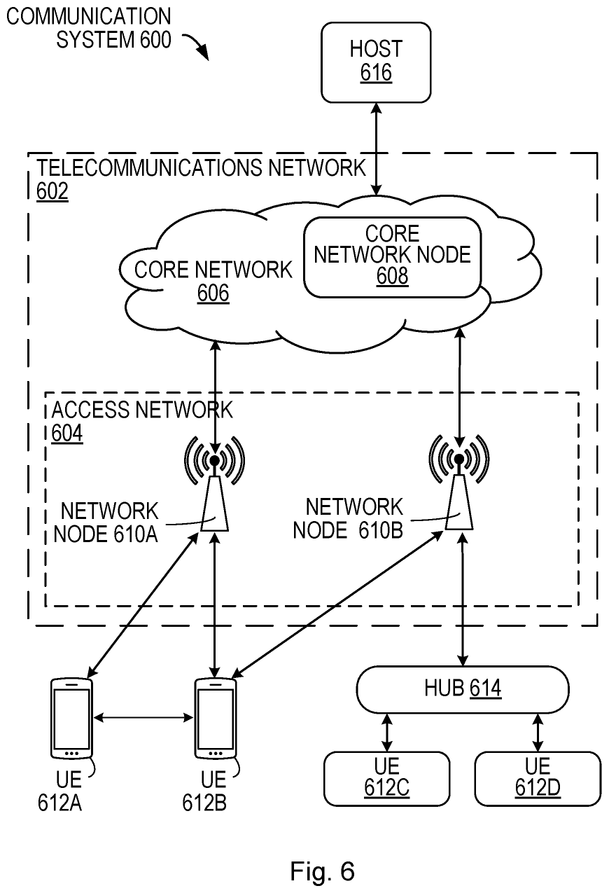

FIG. 4 is a flow chart illustrating a method performed by a UE in accordance with some embodiments. The UE may perform the method in response to executing suitably formulated computer readable code. The UE can correspond to the UE 612 in FIG. 6 below, or UE 700 in FIG. 7 below. The computer readable code may be embodied or stored on a computer readable medium, such as a memory chip, optical disc, or other storage medium. The computer readable medium may be part of a computer program product.

In step 402, the UE performs a connectivity process with a first network node to generate a first key for use by the UE and the first network node. The UE performs the connectivity process using a UE identifier, and the UE sends a correlation identifier to the first network node as part of the connectivity process. The connectivity process can include authenticating the UE to a 5GC. The connectivity process can include an Extensible Authentication Protocol (EAP) process. The first network node may be a TNGF. In this case, the first key is a K-TNGF key.

In step 404, the UE performs a security protocol process with the first network node using the first key. As part of the security protocol process, the UE sends the correlation identifier to the first network node. The security protocol process can be for setting up a security protocol between the UE and a communication network. The security protocol process can be for establishing an Internet Protocol Security (IPSec) tunnel to the first network node.

The UE identifier can be a SUCI; an anonymous identifier; an anonymous SUCI; or a 5G-GUTI. In the case of the UE identifier being an anonymous SUCI, the anonymous SUCI can be an empty string. Alternatively, the anonymous SUCI can comprise a string “anonymous” or an empty string.

The connectivity process in step 402 can comprise the UE sending the correlation identifier and the UE identifier to the first network node. Alternatively the correlation identifier can be used as the UE identifier in the connectivity process of step 402. In this case, the correlation identifier can be sent to the first network node in a UE identifier message field during the connectivity process.

In particular embodiments, the UE identifier is an Anonymous SUCI, and the correlation identifier is sent to the first network node in the Anonymous SUCI. The correlation identifier may be in a username part of the Anonymous SUCI.

The method performed by the UE may further comprise generating the correlation identifier. The correlation identifier may be generated for or generated during the connectivity process with the first network node.

Performing the security protocol process in step 404 can comprise the UE sending the correlation identifier to the first network node as an identifier for the UE.

In step 402 and/or 404, the correlation identifier may be sent to the first network node in Access Network (AN) parameters.

In a subsequent connectivity process with the first network node or another network node, the UE will use a different correlation identifier to that used in steps 402 and 404.

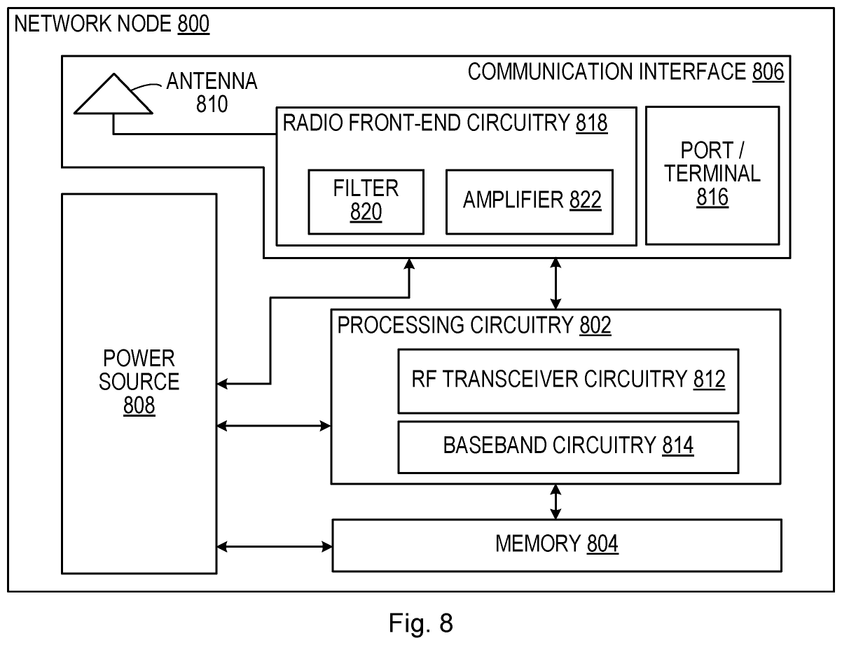

FIG. 5 is a flow chart illustrating a method performed by a first network node in accordance with some embodiments. The first network node may perform the method in response to executing suitably formulated computer readable code. The first network node can correspond to the TNGF described herein, or more generally correspond to the network node 800 in FIG. 8 below. The computer readable code may be embodied or stored on a computer readable medium, such as a memory chip, optical disc, or other storage medium. The computer readable medium may be part of a computer program product.

In step 502, the first network node performs a connectivity process with a UE to generate a first key for use by the UE and the first network node. The UE performs the connectivity process using a UE identifier, and the first network node receives a correlation identifier from the UE as part of the connectivity process. The connectivity process can include authenticating the UE to a 5GC. The connectivity process can include an Extensible Authentication Protocol (EAP) process. In embodiments where the first network node is a TNGF, the first key can be a K-TNGF key.

In step 504, the first network node stores the first key and the correlation identifier for the UE.

In step 506, the first network node performs a security protocol process with the UE, with the process including the first network node receiving the correlation identifier from the UE. The first network node uses the correlation identifier to retrieve the first key. The security protocol process can be for setting up a security protocol between the UE and a communication network. The security protocol process can be for establishing an Internet Protocol Security (IPSec) tunnel to the first network node.

The UE identifier can be a SUCI; an anonymous identifier; an anonymous SUCI; or a 5G-GUTI. In the case of the UE identifier being an anonymous SUCI, the anonymous SUCI can be an empty string. Alternatively, the anonymous SUCI can comprise a string “anonymous” or an empty string.

The connectivity process in step 502 can comprise the first network node receiving the correlation identifier and the UE identifier from the UE. Alternatively the UE can use the correlation identifier as the UE identifier in the connectivity process of step 502. In this case, the correlation identifier can be received from the UE in a UE identifier message field during the connectivity process.

In particular embodiments, the UE identifier is an Anonymous SUCI, and the correlation identifier is received from the UE in the Anonymous SUCI. The correlation identifier may be in a username part of the Anonymous SUCI. Performing the security protocol process in step 506 can comprise the first network node receiving the correlation identifier from the UE, and using the correlation identifier as an identifier for the UE.

In step 502 and/or 506, the correlation identifier may be received from the UE in Access Network (AN) parameters.

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as access network nodes 610a and 610b (one or more of which may be generally referred to as access network nodes 610), or any other similar 3^{rd} Generation Partnership Project (3GPP) access node or non-3GPP access point (AP). The access network nodes 610 facilitate direct or indirect connection of wireless devices (also referred to interchangeably herein as user equipment (UE)), such as by connecting UEs 612a, 612b, 612c, and 612d (one or more of which may be generally referred to as UEs 612) to the core network 606 over one or more wireless connections. The access network nodes 610 may be, for example, access points (APs) (e.g. radio access points), base stations (BSs) (e.g. radio base stations, Node Bs, evolved Node Bs (eNBs) and New Radio (NR) NodeBs (gNBs).

In some embodiments, the access network 604 can be a Trusted Non-3GPP Access Network (TNAN), and the core network 606 can be a 5GC. The network nodes 610 in the TNAN 604 can be Trusted Non-3GPP Access Points (TNAPs). Although not shown in FIG. 6, the TNAN 604 can include a Trusted Non-3GPP Gateway Function (TNGF). The core network node(s) 608 in the 5GC 606 can include an Access and Mobility Management Function (AMF) and an Authentication Server Function (AUSF).

Unless otherwise indicated, the term ‘network node’ is used herein to refer to both (trusted non-3GPP) access network nodes 610 and core network nodes 608.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The wireless devices/UEs 612 may be any of a wide variety of communication devices, including wireless devices arranged, configured, and/or operable to communicate wirelessly with the network nodes 610 and other communication devices. Similarly, the access network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the access network nodes 610 to one or more hosts, such as host 616. These connections may be direct or indirect via one or more intermediary networks or devices. In other examples, network nodes may be directly coupled to hosts. The core network 606 includes one more core network nodes (e.g. core network node 608) that are structured with hardware and software components. Features of these components may be substantially similar to those described with respect to the wireless devices/UEs, access network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2^{nd} Generation (2G), 3^{rd} Generation (3G), 4^{th} Generation (4G), 5^{th} Generation (5G) standards, or any applicable future generation standard (e.g. 6^{th} Generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single-or multi-radio access technology (RAT) or multi-standard mode. For example, a UE may operate with any one or combination of Wi-Fi, NR (New Radio) and LTE, i.e. being configured for multi-radio dual connectivity (MR-DC), such as E-UTRAN (Evolved-UTRA (UMTS Terrestrial Radio Access) Network) New Radio—Dual Connectivity (EN-DC).

In the example illustrated in FIG. 6, the hub 614 communicates with the access network 604 to facilitate indirect communication between one or more UEs (e.g. UE 612c and/or 612d) and access network nodes (e.g. access network node 610b). In some examples, the hub 614 may be a controller, router, a content source and analytics node, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy Internet of Things (IoT) devices.

The hub 614 may have a constant/persistent or intermittent connection to the network node 610b. The hub 614 may also allow for a different communication scheme and/or schedule between the hub 614 and UEs (e.g. UE 612c and/or 612d), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub-that is, a hub whose primary function is to route communications to/from the UEs from/to the network node 610b. In other embodiments, the hub 614 may be a non-dedicated hub-that is, a device which is capable of operating to route communications between the UEs and network node 610b, but which is additionally capable of operating as a communication start and/or end point for certain data channels.

FIG. 7 shows a wireless device or UE 700 in accordance with some embodiments.

As used herein, a UE refers to a device capable, configured, arranged and/or operable to communicate wirelessly with network nodes and/or other UEs. Examples of a wireless device/UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A wireless device/UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g. a smart sprinkler controller). Alternatively, a UE may represent a device that is not intended for sale to, or operation by, an end user but which may be associated with or operated for the benefit of a user (e.g. a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g. in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs). The processing circuitry 702 may be operable to provide, either alone or in conjunction with other UE 700 components, such as the memory 710, to provide UE 700 functionality. For example, the processing circuitry 702 may be configured to cause the UE 702 to perform the methods as described herein.

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g. a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g. an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or integrated SIM (ISIM), other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g. another UE or a network node in an access network). Each transceiver may include a transmitter 718 and/or a receiver 720 appropriate to provide network communications (e.g. optical, electrical, frequency allocations, and so forth). Moreover, the transmitter 718 and receiver 720 may be coupled to one or more antennas (e.g. antenna 722) and may share circuit components, software or firmware, or alternatively be implemented separately.

In some embodiments, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) or other Global Navigation Satellite System (GNSS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g. once every 15 minutes if it reports the sensed temperature), random (e.g. to even out the load from reporting from several sensors), in response to a triggering event (e.g. when moisture is detected an alert is sent), in response to a request (e.g. a user initiated request), or a continuous stream (e.g. a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an IoT device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments.

As used herein, network node refers to equipment capable, configured, arranged and/or operable to communicate directly or indirectly with a UE and/or with other network nodes or equipment, in a telecommunication network. Examples of network nodes include, but are not limited to, access network nodes such as APs (e.g. radio access points), base stations (BSs) (e.g. radio base stations, Node Bs, evolved Node Bs (eNBs) and NR NodeBs (gNBs)) TNAPs and/or TNGFs. Other examples of network nodes include, but are not limited to, core network nodes such as nodes that include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs), and/or Minimization of Drive Tests (MDTs).

The network node 800 includes processing circuitry 802, a memory 804, a communication interface 806, and a power source 808, and/or any other component, or any combination thereof. The network node 800 may be composed of multiple physically separate components (e.g. a NodeB component and a RNC component, or a BTS component and a BSC component, etc.), which may each have their own respective components. In certain scenarios in which the network node 800 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g. separate memory 804 for different RATs) and some components may be reused (e.g. a same antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality. For example, the processing circuitry 802 may be configured to cause the network node to perform the methods described herein.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signalling and/or data between network nodes, the access network, the core network, and/or a UE. As illustrated, the communication interface 806 comprises port(s)/terminal(s) 816 to send and receive data, for example to and from a network over a wired connection.

In embodiments where the network node 800 is an access network node (e.g. a TNAP), the communication interface 806 also includes radio front-end circuitry 818 that may be coupled to, or in certain embodiments a part of, the antenna 810. In embodiments where the network node 800 is a core network node, or where the network node 800 is a TNGF, the core network node may not include radio front-end circuitry 818 and antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the access network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g. at a voltage and current level needed for each respective component). The power source 808 may further comprise, or be coupled to, power management circuitry to supply the components of the network node 800 with power for performing the functionality described herein. For example, the network node 800 may be connectable to an external power source (e.g. the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

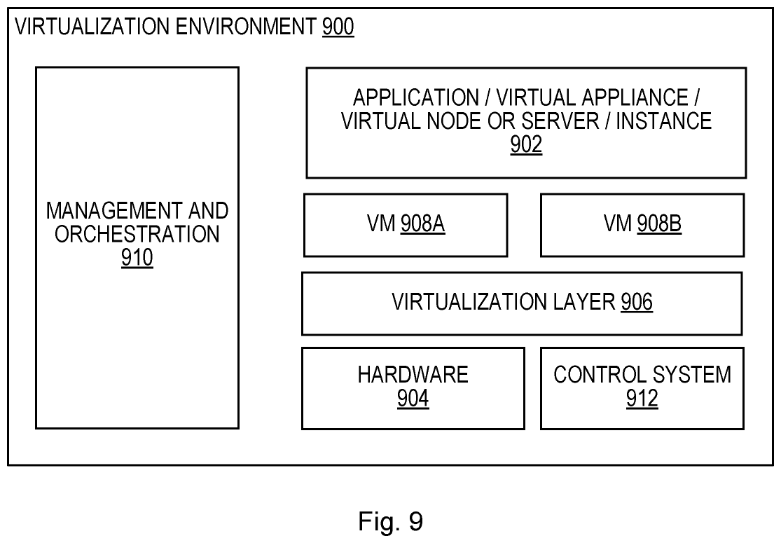

FIG. 9 is a block diagram illustrating a virtualization environment 900 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as an access network node, a TNAP, a TNGF, a wireless device/UE, or a core network node. Further, in embodiments in which the virtual node does not require radio connectivity (e.g. a TNGF or a core network node), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

Although the computing devices described herein (e.g. UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware. In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### EMBODIMENTS

### Group a Embodiments

1. A method performed by a user equipment, UE, the method comprising:
performing a connectivity process with a first network node to generate a first key for use by the UE and the first network node, wherein the UE performs the connectivity process using an identifier, and wherein performing the connectivity process comprises sending, to the first network node, a correlation identifier; and
performing a security protocol process with the first network node using the first key, wherein performing the security protocol process comprises sending, to the first network node, the correlation identifier.

2. The method of embodiment 1, wherein the security protocol process is for setting up a security protocol between the UE and a communication network.

3. The method of embodiment 1 or 2, wherein the identifier is a Subscription Concealed Identifier, SUCI; an anonymous identifier; an anonymous SUCI; or a 5^{th} Generation-Global Unique Temporary Identity, 5G-GUTI.

4. The method of embodiment 3, wherein the anonymous SUCI is an empty string.

5. The method of any of embodiments 1-4, wherein performing the connectivity process comprises sending the correlation identifier and the anonymous identifier to the first network node.

6. The method of any of embodiments 1-4, wherein performing the connectivity process comprises using the correlation identifier as the anonymous identifier.

7. The method of embodiment 6, wherein performing the connectivity process comprises sending the correlation identifier to the first network node in a UE identifier message field.

8. The method of embodiment 1-7, wherein the method further comprises:
generating the correlation identifier.

9. The method of embodiment 8, wherein the correlation identifier is generated for or generated during the connectivity process with the first network node.

10. The method of any of embodiments 1-9, wherein performing the security protocol process comprises sending the correlation identifier to the first network node as an identifier for the UE.

11. The method of any of embodiments 1-10, wherein the method further comprises using a different correlation identifier for a subsequent connectivity process with the first network node or another network node.

12. The method of any of embodiments 1-11, wherein the connectivity process includes an Extensible Authentication Protocol, EAP, process.

13. The method of any of embodiments 1-12, wherein the security protocol process is for establishing an Internet Protocol Security, IPSec, tunnel to the first network node.

14. The method of any of embodiments 1-13, wherein the first network node is a Trusted Non-Third Generation Partnership Project Gateway Function, TNGF.

15. The method of embodiment 14, wherein the first key is a K-TNGF key.

16. The method of any of embodiments 1-15, wherein the connectivity process includes authenticating the UE to a 5^{th} Generation Core, 5GC.

### Group B Embodiments

17. A method performed by a first network node, the method comprising:
performing a connectivity process with a user equipment, UE, to generate a first key for use by the UE and the first network node, wherein the UE performs the connectivity process using an identifier, and wherein performing the connectivity process comprises receiving, from the UE, a correlation identifier;
storing the first key and the correlation identifier for the UE; and
performing a security protocol process with the UE, wherein performing the security protocol process comprises receiving, from the UE, the correlation identifier, and using the correlation identifier to retrieve the first key.

18. The method of embodiment 17, wherein the security protocol process is for setting up a security protocol between the UE and a communication network.

19. The method of embodiment 17 or 18, wherein the identifier is a Subscription Concealed Identifier, SUCI; an anonymous identifier; an anonymous SUCI; or a 5^{th} Generation-Global Unique Temporary Identity, 5G-GUTI.

20. The method of embodiment 19, wherein the anonymous SUCI is an empty string.

21. The method of any of embodiments 17-20, wherein performing the connectivity process comprises receiving the correlation identifier and the anonymous identifier from the UE.

22. The method of any of embodiments 17-20, wherein performing the connectivity process comprises receiving the correlation identifier as the anonymous identifier.

23. The method of embodiment 22, wherein performing the connectivity process comprises receiving the correlation identifier from the UE in a UE identifier message field.

24. The method of any of embodiments 17-23, wherein performing the security protocol process comprises receiving the correlation identifier from the UE as an identifier for the UE.

25. The method of any of embodiments 17-24, wherein the connectivity process includes an Extensible Authentication Protocol, EAP, process.

26. The method of any of embodiments 17-25, wherein the security protocol process is for establishing an Internet Protocol Security, IPSec, tunnel between the first network node and the UE.

27. The method of any of embodiments 17-26, wherein the first network node is a Trusted Non-Third Generation Partnership Project Gateway Function, TNGF.

28. The method of embodiment 27, wherein the first key is a K-TNGF key.

29. The method of any of embodiments 17-28, wherein the connectivity process includes authenticating the UE to a 5^{th} Generation Core, 5GC.

### Group C Embodiments

30. A computer program product comprising a computer readable medium having computer readable code embodied therein, the computer readable code being configured such that, on execution by a suitable computer or processor, the computer or processor is caused to perform the method of any of the Group A embodiments or the Group B embodiments.

31. A user equipment, UE, configured to perform the method of any of the Group A embodiments.

32. A user equipment, UE, comprising a processor and a memory, said memory containing instructions executable by said processor whereby said UE is operative to perform the method of any of the Group A embodiments.

33. A network node, configured to perform the method of any of the Group B embodiments.

34. A network node comprising a processor and a memory, said memory containing instructions executable by said processor whereby said network node is operative to perform the method of any of the Group B embodiments.

35. A user equipment, comprising:
processing circuitry configured to cause the user equipment to perform any of the steps of any of the Group A embodiments; and
power supply circuitry configured to supply power to the processing circuitry.

36. A network node, the network node comprising:
processing circuitry configured to cause the network node to perform any of the steps of any of the Group B embodiments;
power supply circuitry configured to supply power to the processing circuitry.

37. A user equipment, UE, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments; an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

1-40. (canceled)

41. A method performed by a user equipment (UE) the method comprising:
performing a connectivity process with a first network node to generate a first key for use by the UE and the first network node, wherein the UE performs the connectivity process using a UE identifier, and wherein performing the connectivity process comprises sending, to the first network node, a correlation identifier; and
performing a security protocol process with the first network node using the first key, wherein performing the security protocol process comprises sending, to the first network node, the correlation identifier.

42. The method of claim 41, wherein the UE identifier is one of a Subscription Concealed Identifier (SUCI), an anonymous identifier, an anonymous SUCI, or a 5^{th} Generation-Global Unique Temporary Identity (5G-GUTI).

43. The method of claim 41, wherein the UE identifier is an anonymous Subscription Concealed Identifier (SUCI) and the anonymous SUCI is an empty string or comprises the string “anonymous”.

44. The method of claim 41, wherein performing the connectivity process comprises:
sending the correlation identifier and the UE identifier to the first network node;
and/or using the correlation identifier as the UE identifier; and/or sending the correlation identifier to the first network node in a UE identifier message field.

45. The method of claim 41, wherein the UE identifier is an Anonymous Subscription Concealed Identifier (SUCI) and wherein the correlation identifier is sent to the first network node in the Anonymous SUCI.

46. The method of claim 41, wherein the UE identifier is an Anonymous Subscription Concealed Identifier (SUCI) and wherein the correlation identifier is sent to the first network node in the Anonymous SUCI and wherein the correlation identifier is in a username part of the Anonymous SUCI.

47. The method of claim 41, wherein the method further comprises generating the correlation identifier.

48. The method of claim 41, comprising generating the correlation identifier, wherein the correlation identifier is generated for or generated during the connectivity process with the first network node.

49. The method of claim 41, wherein performing the security protocol process comprises sending the correlation identifier to the first network node as an identifier for the UE.

50. The method of claim 41, wherein the correlation identifier is sent to the first network node in Access Network (AN) parameters.

51. The method of claim 41, wherein the method further comprises using a different correlation identifier for a subsequent connectivity process with the first network node or another network node.

52. The method of claim 41, wherein the connectivity process includes an Extensible Authentication Protocol (EAP) process; and/or wherein the security protocol process is for establishing an Internet Protocol Security (IPSec) tunnel to the first network node.

53. The method of claim 41, wherein the first network node is a Trusted Non-Third Generation Partnership Project Gateway Function (TNGF).

54. The method of claim 41, wherein the connectivity process includes authenticating the UE to a 5th Generation Core (5GC).

55. A method performed by a first network node, the method comprising:
performing a connectivity process with a user equipment (UE) to generate a first key for use by the UE and the first network node, wherein the UE performs the connectivity process using a UE identifier, and wherein performing the connectivity process comprises receiving, from the UE, a correlation identifier;
storing the first key and the correlation identifier for the UE; and
performing a security protocol process with the UE, wherein performing the security protocol process comprises receiving, from the UE, the correlation identifier, and
using the correlation identifier to retrieve the first key.

56. The method of claim 55, wherein the UE identifier is one of a Subscription Concealed Identifier (SUCI), an anonymous identifier an anonymous SUCI, or a 5^{th} Generation-Global Unique Temporary Identity (5G-GUTI).

57. The method of claim 55, wherein the UE identifier is an anonymous Subscription Concealed Identifier (SUCI) and wherein the anonymous SUCI is an empty string or comprises the string “anonymous”.

58. The method of claim 55, wherein performing the connectivity process comprises:
receiving the correlation identifier and the UE identifier from the UE;
and/or receiving the correlation identifier as the UE identifier;
and/or receiving the correlation identifier from the UE in a UE identifier message field.

59. The method of claim 55, wherein the UE identifier is an Anonymous Subscription Concealed Identifier (SUCI) and wherein the correlation identifier is received from the UE in the Anonymous SUCI.

60. The method of claim 55, wherein the first network node is a Trusted Non-Third Generation Partnership Project Gateway Function (TNGF).

61. The method of claim 55, wherein the first network node is a Trusted Non-Third Generation Partnership Project Gateway Function (TNGF) and wherein the first key is a K-TNGF key.

62. A computer program product comprising a computer readable medium having computer readable code stored therein, the computer readable code being configured such that, on execution by a suitable processor of a User Equipment (UE), the processor controls the UE to:
perform a connectivity process with a first network node to generate a first key for use by the UE and the first network node, wherein the UE performs the connectivity process using a UE identifier, and wherein performing the connectivity process comprises sending, to the first network node, a correlation identifier; and
perform a security protocol process with the first network node using the first key, wherein performing the security protocol process comprises sending, to the first network node, the correlation identifier.

63. A user equipment (UE) comprising:
a processor; and
a memory containing instructions executable by said processor whereby said processor controls the UE to:
perform a connectivity process with a first network node to generate a first key for use by the UE and the first network node, wherein the UE performs the connectivity process using a UE identifier, and wherein performing the connectivity process comprises sending, to the first network node, a correlation identifier; and
perform a security protocol process with the first network node using the first key, wherein performing the security protocol process comprises sending, to the first network node, the correlation identifier.

64. A network node comprising:
a processor; and
a memory containing instructions executable by said processor whereby the processor controls the network node to:
perform a connectivity process with a user equipment, UE, to generate a first key for use by the UE and the first network node, wherein the UE performs the connectivity process using a UE identifier, and wherein performing the connectivity process comprises receiving, from the UE, a correlation identifier;
store the first key and the correlation identifier for the UE; and
perform a security protocol process with the UE, wherein performing the security protocol process comprises receiving, from the UE, the correlation identifier, and using the correlation identifier to retrieve the first key.
